(19) United States
(12) Patent Application Publication
(10) Pub. No.: US 2013/0054380 A1
(43) Pub. Date: Feb. 28, 2013

(54) Social media lifecycle marketing

(71) Applicants: Adam Matthew Root, Dallas, TX (US); Lindsey Ann Root, Dallas, TX (US); Bernard Kenneth Perrine, Lincolnshire, IL (US)

(72) Inventors: Adam Matthew Root, Dallas, TX (US); Lindsey Ann Root, Dallas, TX (US); Bernard Kenneth Perrine, Lincolnshire, IL (US)

(21) Appl. No.: 13/199,305

(22) Filed: Aug. 25, 2011

(51) Int. Cl. G06Q 30/02

(52) U.S. Cl. 705/14.73

(57) ABSTRACT

A marketing system includes a prospect collecting landing page, an offer call-to-action landing page, and an automated communicated subsystem that interconnects the prospect collecting landing page and the offer call-to-action landing page. The system can further include a refer-a-friend call-to-action landing page, and an automated communication subsystem that interconnects the offer call-to-action landing page and the refer-a-friend call-to-action landing page.

### I. FIELD

The present disclosure relates generally to systems and methods to find prospects for a business on social media, convert those prospects into customers of the business, and incentivize customers to refer their friends to the business.

### II. DESCRIPTION OF RELATED ART

According to Cone Research, 97% of Americans say that they are more likely to try a product or service if a social network friend recommends it.

That fact makes it clear that an effective marketing strategy is to incentivize customers to recommend the business to their social media friends.

While social networking is exploding with over 157 million users in the United States alone, social networking growth has happened so recently that a system and method for finding prospects for a business on social media, converting those prospects into customers of the business, and incentivizing customers to refer their friends to the business has heretofore not been developed. Having such a system would be a marketing boom for businesses. Providing such a system is the goal of the present invention.

### III. SUMMARY

In a particular embodiment, a marketing system includes a prospect collecting landing page, an offer call-to-action landing page, and an automated communication subsystem that interconnects the prospect collecting landing page and the offer call-to-action landing page.

In another particular embodiment, a programmed computer includes first computer readable code for causing the computer to automatically send information to a person who requests it via an information landing page and for driving the person to an offer call-to-action landing page, second computer readable code for causing the computer to automatically send a coupon to a person who requests it via the offer call-to-action landing page and for incentivizing a person to a refer-a-friend landing page, and third computer readable code for causing the computer to automatically thank a person who refers a friend via the refer-a-friend landing page with an incentive and for driving the referred friend to a landing page that deals with the business.

In another particular embodiment, a computer readable medium includes operational instructions, that when executed by a processor, cause the processor to automatically thank people who refer a friend to a business; and operational instructions, that when executed by the processor, cause the processor to automatically direct the friend to a landing page that deals with the business.

One particular advantage provided by embodiments of the claimed lifecycle marketing system and method is to enable businesses to automatically grow its customer base. Another particular advantage is to enable businesses to maximize referrals and recommendations. Yet another particular advantage of embodiments is to collect information that can be used by the business to evaluate—and improve—their marketing efforts.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is an illustrative embodiment of a lifecycle marketing system.

### V. DETAILED DESCRIPTION

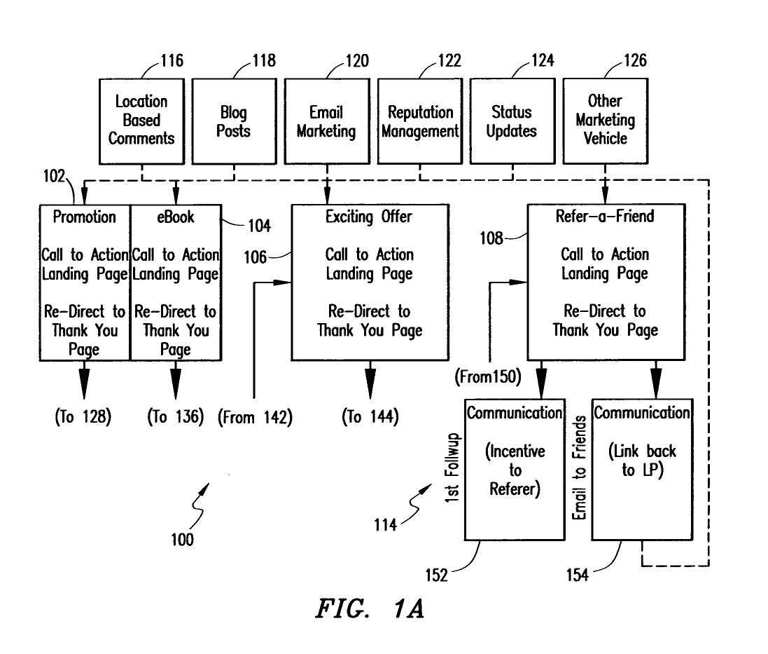

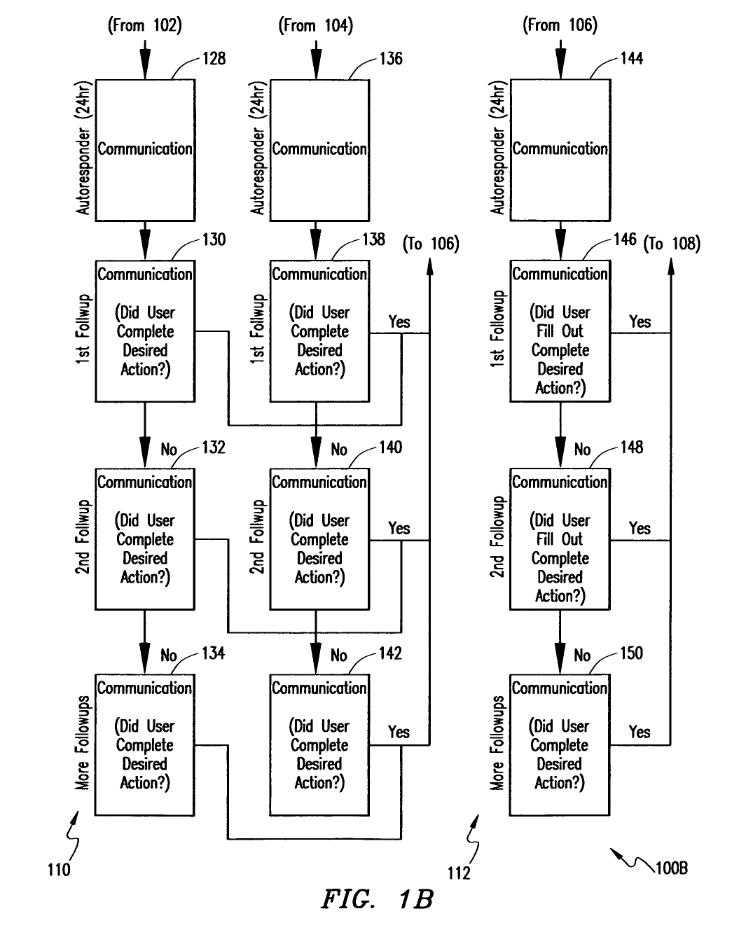

Referring to FIG. 1, the depicted lifecycle marketing system is generally designated 100.

Lifecycle marketing system 100 includes at least one prospect call-to-action collecting landing page 102, 104; an offer call-to-action landing page 106; a refer-a-friend call-to-action landing page 108; an automated communications system 110 interconnecting the prospect collecting call-to-action landing pages 102, 104 and the offer call-to-action landing page 106; an automated communications system 112 interconnecting the offer call-to-action landing page 106 and the refer-a-friend call-to-action landing page; and an automated communications system 114 that interconnects the refer-a-friend call-to-action landing page with the prospect collecting landing pages 102,104 and/or the offer call-to-action landing page 106. Each of the elements of lifecycle marketing system 100 will be discussed in further detail below.

Lifecycle marketing system 100 is designed to appeal to three different types of people: shoppers, scholars, and socializers. Shoppers are people who are constantly looking for an offer, like a discount. Shoppers like interacting with brands that offer discounts. Scholars are people who like to research before they purchase. Scholars like to download ebooks, read blog posts, and subscribe to newsletters. Socializers enjoy interacting with brands on social networks through promotions, status updates, and the like.

Lifecycle marketing system 100 targets visitors by having an offer call-to-action landing page 106. The offer call-to-action landing page is a website that enables visitors to obtain a free or reduced price product or service provided they use a particular business. For example, an offer call-to-action landing page 106 could enable visitors to get a free lamp set by visiting a store and purchasing a sofa, love seat, or recliner. Alternatively, an offer call-to-action landing page could enable visitors to “click here” for a discount coupon for a meal at a particular restaurant. Any offer that is likely to appeal to a visitor—to convert them into a customer—could be presented on the offer call-to-action page 106.

Visitors can be directed to the offer call-to-action page 106 a number of different ways.

One way—especially designed to attract shoppers—is via location-based comments (designated by block 116). Social network feeds can be monitored and people in a particular location, having a particular interest (based on the keywords they use in communications), and having a particular influence rating (based on a users ability to drive a desired action from their friends) identified. People who are ideally located, interested, and influential to become a customer/ambassador of a business can then be sent a comment via the social network feed they used keywords on originally, which comment includes a link to the offer call-to-action landing page 106. For example, someone may post: “I am looking to freshen up my apartment, but I′m on a budget. Help!” In response, a furniture store could send a message saying, “Check out our free lamp offer” and include a link to the offer call-to-action landing page 106.

Another way—especially designed to appeal to scholars—is via blog posts (designated by block 118). For example, a blog post could include information about a particular business, coupled with a link to the offer call-to-action landing page 106. By such means, a scholar could both learn about a business and be offered a quick, easy, and cost effective way to use it.

Yet another way is via email marketing (designated by block 120). For example, email messages could be sent to a business's current customers (for which email addresses are on hand), which email messages could direct a user to one of the call-to-action landing pages. As an example an email message could be sent to a user containing a link to the offer call-to-action landing page 106, which coupon is designed to make them even better customers.

Still yet another way a person could be directed to the offer call-to-action landing page 106 is via reputation management comments (designated by block 122). One example is a reputation management comment could be made in response to a negative comment or review located during monitoring of social network feeds. One could refer a negative poster or reviewer to the offer call-to-action landing page 106 to ideally improve their level of satisfaction. An additional example is a reputation management comment in response to a positive post or review located during monitoring of social network feeds. One could refer the positive poster or reviewer to the refer-a-friend landing page so that the user may encourage their friends to try the business.

Still yet another way—especially designed to appeal to socializers—is via status updates (designated by block 124). For example the business could send out a message on a microblog service (like Twitter) saying they could “Learn how to [accomplish whatever],” including a link to the offer call-to-action landing page 106.

There are other ways that a person could directly be referred to the offer call-to-action landing page 106. For example, a newsletter including a link to the offer call-to-action landing page 106 could be sent to likely “scholars.” Other ways either exist now or could be developed. All of these ways are designated by block 126. All ways of reaching a person and directing them to the offer call-to-action landing page 106 are encompassed within the scope of the present invention, as claimed.

As shown in FIG. 1, the various ways 116, 118, 120, 122, 124, and 126 of referring a person to the offer call-to-action landing page 106 can also refer the person to the promotion call-to-action landing page 102 or the ebook downloading call-to-action landing page 104 or the refer-a-friend call-to-action landing page 108. For example, if a person uses keywords in a social network posting that indicates they are a socializer, they can be directed to the promotion call-to-action landing page 102. As another example, if a person uses keywords in a social network posting that indicates they are a scholar, they can be directed to the ebook downloading call-to-action landing page 104. As yet another example, if a person is known to be good customer already, they can be directed with comments, status updates, or the like to the refer-a-friend call-to-action landing page 108.

In addition to the “direct” ways 116, 118, 120, 122, 124, and 126 of referring a person to the offer call-to-action landing page 106 (or one or more of the other call-to-action landing pages 102, 104, 108), there are at least two “indirect” (i.e., focusing on a matter other than an offer, such as a sweepstakes, or an ebook) ways of making such a referral too.

One possible indirect way—especially designed to appeal to socializers—is via a promotion (designated by block 102). According to Forrester Research, businesses that have contests have twice as many “likes” (e.g., on Facebook) as those that don't. The promotion would, for example, have an “enter sweepstakes” button that would present a form that a person could complete for the chance to win a prize.

Yet another indirect way—designed to appeal to scholars—is via an ebook download page (designated by block 104). Such a page could say something like: “A wealth of knowledge is waiting for you in our FREE ebook.” The ebook download page 104 would ideally be constructed so that it would be easily found by a socializer's search engine.

The promotion and ebook lifecycle marketing entry points 102, 104—which are really prospect collecting call-to-action landing pages—are connected to similar automated paths. In the case of the promotion, a person can be automatically sent a message thanking them for entering the sweepstake (designated by block 128), and then sometime later (for example: one week), the person can be automatically be sent another communication directing them to the offer call-to-action landing page 106 (designated by block 130). If they do not fill out a form on the offer call-to-action landing page 106 based on receipt of this first message, sometime later (for example, another week), they can receive a follow-up communication directing them to the offer call-to=action landing page 106 again (saying something like this is their LAST CHANCE to receive a great, special offer)(designated by block 132). Any number of follow-up messages (designated by block 134), leading to the “last chance” communication could be used in embodiments of the present invention. According to Harper College, 80% of sales are lost because of poor follow-up. As follow-up in embodiments of the present invention is automated, follow-up cannot be poor.

In embodiments of the present invention “messages” or “communications” or the like should be understood to encompass emails, text messages, and any other form of communication presently used or that may be used during the patent term.

In the case of an ebook download, the downloader can be automatically thanked for getting the ebook (designated by block 136). Then, sometime later, the downloader can be encouraged to go to the offer call-to-action landing page 106 (designated by block 138). If the downloader does not fill out a form for a coupon at the offer call-to-action landing page, he or she can be sent at least one follow-up message (a second follow-up message designated by block 138, and third and more follow-ups designated by blocks 140 and 142). Embodiments of the present invention can be structured so follow-up messages are not so numerous or frequent to be pestering; however, follow-up does occur.

Like the ebook landing page 104 is connected to the offer call-to-action landing page 106, the offer call-to-action landing page 106 is connected to a refer-a-friend call-to-action landing page 108. That is to say, shortly after a visitor completes a form to obtain a coupon at the offer call-to-action landing page 106, he or she is sent a thank you message (designated by block 144). Then, sometime later (approximately one week) he or she is sent a message directing him or her to the refer-a-friend call-to-action landing page 108 (designated by block 146). At the refer-a-friend call-to-action landing page 108, the visitor can be asked for contact information for some number (possibly, three to five) of their friends. The visitor can be told referred friends will get offers from the business too. Ideally, the visitor would have had a good experience with the business by this point, and would be happy to refer the business to their friends. The visitor may be further encouraged to refer friends by, for example, giving them free downloaded music for referring friends. Also like the ebook/offer landing page 104/106 connection, which allows for follow-up messages if needed, follow-up messages may also be allowed in the offer/refer-a-friend landing page connection 106/108 in embodiments of the present invention (this capability is designated by blocks 148 and 150).

System 100 also is set up to automatically send a thank you message (designated by block 152) to a person who refers their friends via refer-a-friend call-to-action landing page 108.

Additionally, system 100 is set up to automatically send an message to all people referred (designated by block 154), directing them to the offer call-to-action landing page 106 and/or to the promotion call-to-action landing page 102 and/or to the ebook download call-to-action landing page 104.

The system and method of the present invention offer a number of advantages over the prior art. One particular advantage provided by embodiments of the claimed system and method is that those embodiments enable businesses to deliver highly targeted and actionable communications across the vast network of social media platforms. Embodiments of the present invention can drive traffic to call-to-action pages, providing trackable, measurable conversion. Embodiments of the present invention ensure that follow-up occurs. Further, embodiments of the present invention increase customer bases, and encourage customers to refer the business to their friends, which is the best known way to grow a business.

Those of skill will appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A marketing system comprising:
a prospect collecting landing page;
an offer call-to-action landing page; and
an automated communications subsystem that interconnects the prospect collecting landing page and the offer call-to-action landing page.

2. The marketing system of claim 1, further comprising:
a refer-a-friend call-to-action landing page; and
an automated communications subsystem that interconnects the offer call-to-action landing page and the refer-a-friend call-to-action landing page.

3. The marketing system of claim 2, further comprising:
an automated communications subsystem that thanks a person for making a referral on the refer-a-friend call-to-action landing page and that directs referrals to a call-to-action landing page.

4. The marketing system of claim 1, wherein the prospect collecting landing page provides information to a visitor.

5. The marketing system of claim 4, wherein the information is an ebook.

6. The marketing system of claim 4, wherein the information deals with entry into a sweepstakes.

7. The marketing system of claim 1, wherein the automated communications subsystem comprises a thank you communication.

8. The marketing system of claim 7, wherein the automated communications subsystem further comprises a plurality of messages directing the prospect to the offer call-to-action landing page.

9. A programmed computer, comprising:
first computer readable code for causing the computer to automatically send information to a person who requests it via a prospect collecting landing page and for driving the person to an offer landing page;
second computer readable code for causing the computer to automatically send a coupon to a person who requests it via the offer landing page and for incentivizing the person to a refer-a-friend landing page; and
third computer readable code for causing the computer to automatically thank a person who refers a friend via the refer-a-friend landing page and for driving the friend to at least one of the prospect collecting and offer landing pages.

10. The programmed computer of claim 9, wherein the first computer readable code comprises a first communication thanking a person and a second communication encouraging the person to visit the offer landing page.

11. The programmed computer of claim 10, wherein the first readable code further comprises a communication encouraging the person to visit the offer landing page, which third communication is not sent if the person requested an offer after the second communication was sent.

12. The programmed computer of claim 9, wherein the second readable code comprises a first communication thanking a person and a second communication encouraging the person to visit the refer-a-friend landing page.

13. The programmed computer of claim 12, wherein the second readable code further comprises a third communication encouraging the person to visit the refer-a-friend landing page, which third communication is not sent if the person referred at least one friend after the second communication was sent.

14. The programmed computer of claim 9, wherein the third readable code comprises a first communication thanking a person for referring at least one friend and a second communication encouraging a referred friend to visit at least one of the prospect collecting and offer landing pages.

15. A computer readable medium, comprising:
operational instructions, that when executed by a processor, cause the processor to automatically thank people who refer a friend to a business; and
operational instructions, that when executed by the processor, cause the processor to automatically direct the friend to a landing page that deals with the business.

16. The computer readable medium of claim 15, further comprising:
operational instructions, that when executed by the processor, cause the processor to automatically deliver information to a person who requests the information, thereby making them an information recipient.

17. The computer readable medium of claim 16, further comprising:
operational instructions, that when executed by a processor, cause the processor to automatically direct the information recipient to a landing page making an offer.

18. The computer readable medium of claim 17, wherein people who use the offer at the offer landing page become customers, and further comprising:
operational instructions, that when executed by a processor, cause the processor to automatically direct customers to a landing page asking for referral of a friend.

19. The computer readable medium of claim 15, wherein the landing page that deals with a business is an ebook downloading page.

20. The computer readable medium of claim 15, wherein the landing page that deals with a business is a sweepstakes promotion page.
